(19) United States
(12) Patent Application Publication
(10) Pub. No.: US 2026/0289776 A1
(43) Pub. Date: Sep. 24, 2026

(54) SYSTEM AND METHOD FOR IMAGING OF TISSUE SAMPLES

(71) Applicant: Genentech, Inc., South San Francisco, CA (US)

(72) Inventors: Tyler RISOM, San Francisco, CA (US); Mike REICHELT, Mountain View, CA (US)

(21) Appl. No.: 19/687,442

(22) Filed: May 26, 2026

Related U.S. Application Data
(63) Continuation of application No. PCT/US24/60091, filed on Dec. 13, 2024.
(60) Provisional application No. 63/613,998, filed on Dec. 22, 2023.

(51) Int. Cl. G06T 7/00; G01N 1/30; G01N 1/42; G06T 7/11

(52) U.S. Cl. CPC G06T 7/0012; G01N 1/30; G01N 1/42; G06T 7/11; G06T 2207/10036; G06T 2207/10061; G06T 2207/20016; G06T 2207/30024

(57) ABSTRACT

The present disclosure involves generating a view of a tissue section that combines a scanning electron microscope image with a mass spectrometry image of the tissue section. Specifically, a scanning electron microscope image of at least a first portion of an ultramicrotome tissue section of a tissue sample is generated using a scanning electron microscope. Also, a mass spectrometry image of at least a second portion of the ultramicrotome tissue section is generated using a mass spectrometry imaging platform, where the mass spectrometry image depicts an antibody labeling of at least one element. The scanning electron microscope image is registered with the mass spectrometry image.

### CROSS REFERENCE TO RELATED APPLICATIONS

This application is a continuation application of PCT Application No. PCT/US 2024/60091, filed on Dec. 13, 2024, which application claims priority to, and the benefit of, U.S. Provisional Patent Application number 63/613,998 filed on 22 Dec. 2023.

### BACKGROUND

Electron microscopy (EM) of biological samples can provide structural information about cell and tissue architecture with unparalleled detail and context in the nanometer range. Within such biological samples, the use of antigen detection can provide information about the location of certain antigens or therapeutic molecules of interest. However, in the context of high resolution electron microscopy, the use of antigen detection can be very restricted in an ultra-structural context. In addition, sizes of tissue samples that are viewable by electron microscopy are still very small. For example, the size of such tissue samples are less than 0.5 square millimeters and are not large enough to be able to consistently target specific structures to be viewed.

### SUMMARY

In accordance with the present disclosure, a method is provided that comprises generating a scanning electron microscope image of at least a first portion of an ultramicrotome tissue section of a tissue sample using a scanning electron microscope, generating a mass spectrometry image of at least a second portion of the ultramicrotome tissue section using a mass spectrometry imaging platform, where the mass spectrometry image depicts an antibody labeling of at least one element, and registering the scanning electron microscope image with the mass spectrometry image.

In addition, a system is provided that comprises a scanning electron microscope image generated using a scanning electron microscope and stored in at least one memory, the scanning electron microscope image depicting at least a first portion of an ultramicrotome tissue section of a tissue sample, a mass spectrometry image generated using a mass spectrometry imaging platform and stored in the at least one memory, the mass spectrometry image depicting at least a second portion of the ultramicrotome tissue section, and at least one processor circuit configured to execute instructions, that cause the at least one processor circuit to register the scanning electron microscope image with the mass spectrometry image.

Still further, a non-transitory, computer-readable medium is provided comprising machine-readable instructions that, when executed by a processor of a computing device, cause the computing device to register a scanning electron microscope image with a mass spectrometry image to generate a multilayer image, where the scanning electron microscope image depicts at least a first portion of an ultramicrotome tissue section of a tissue sample using a scanning electron microscope, and the mass spectrometry image depicts at least a second portion of the ultramicrotome tissue section using a mass spectrometry imaging platform, the second portion of the ultramicrotome tissue section at least partially overlapping the first portion of the ultramicrotome tissue section.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described features are usable in all portions of the disclosure taught herein. Furthermore, the individual features of the dependent claims, as well as all optional and preferred features and modifications of the present disclosure are combinable and interchangeable with one another.

### BRIEF DESCRIPTION OF THE DRAWINGS

Many features and examples of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates the generation of a tissue sample from a raw tissue sample in accordance with the present disclosure.

FIGS. 2A and 2B illustrate a soaking of a tissue sample in accordance with the present disclosure.

FIG. 3 depicts a flash freezing of a tissue sample that is subjected to cryostat sectioning in accordance with the present disclosure.

FIGS. 4A, 4B, and 4C depict further processing of a cryostat tissue section obtained from the tissue sample of FIG. 1 in accordance with the present disclosure.

FIGS. 5A and 5B depict examples of tissue samples taken from a cryostat tissue section as depicted in FIGS. 4A, 4B, and 4C in accordance with the present disclosure.

FIGS. 6A-6H are drawings depicting the preparation of ultramicrotome tissue sections and the generation of images of the same in accordance with the present disclosure.

FIG. 7 depicts a computing device upon which an image registration application is executed in accordance with the present disclosure.

FIG. 8 is a flowchart depicting the functionality of the image registration application of FIG. 7 in accordance with the present disclosure.

FIG. 9 is a flowchart of a method for generating and registering images from high resolution platforms in accordance with the present disclosure.

### DETAILED DESCRIPTION

Disclosed are various approaches for creating cryostat tissue sections of a raw tissue sample from which further sections may be taken that can be used for high resolution imaging such as electron microscopy, or other high resolution imaging technologies. The cryostat tissue sections can provide for the ability to create wide scale tissue sections that are suitable for high resolution imaging such as electron microscopy, or other high resolution imaging technologies.

According to present disclosure, a cryostat tissue section is subjected to labeling using metal-conjugated antibodies, stains, and other types of markers or labels. Thereafter, the cryostat tissue section is separated into multiple ultramicrotome tissue sections. A scanning electron microscope image of one of the ultramicrotome tissue sections is generated using a scanning electron microscope. Also, a mass spectrometry image of the same ultramicrotome tissue section is generated using a mass spectrometry imaging platform. The scanning electron microscope image may be registered with the mass spectrometry imaging platform.

Although the following discussion provides illustrative examples of the operation of various components of the present disclosure, the use of the following illustrative examples does not exclude other implementations that are consistent with the principles disclosed by the following illustrative examples.

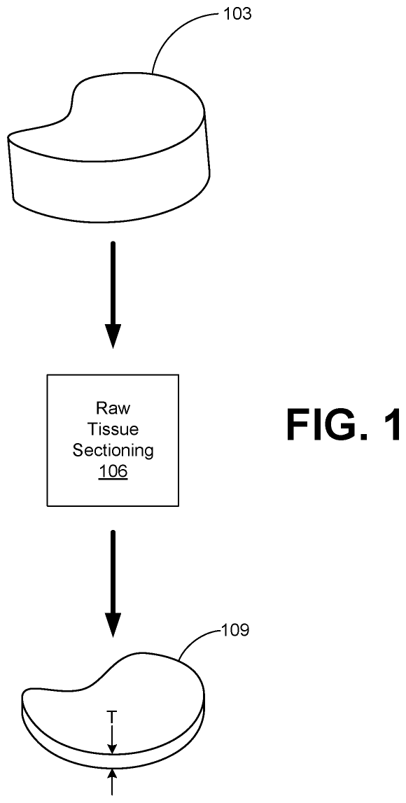

With reference to FIG. 1, shown is a raw tissue sample 103 that is to be processed in accordance with the present disclosure. The raw tissue sample 103 may comprise, for example, tissue taken from a kidney, brain, liver, tonsil, or other organs or structures. The raw tissue sample 103 may be taken from organs of a human, an animal, plant, or other living organism.

The raw tissue sample 103 is subjected to a chemical fixative to promote morphological preservation. According to one example of the present disclosure, the raw tissue sample 103 is subjected to a “light” fixation to prevent the fixative from interfering with later processes as will be described. This may entail subjecting the raw tissue sample 103 to a fixative such as 4% paraformaldehyde (PFA), which is compatible with downstream immunohistochemistry applications, or 2% paraformaldehyde with 2% glutaraldehyde for downstream morphology imaging applications such as electron microscopy. Given that such a light fixation is applied to the raw tissue sample 103, the time from when the raw tissue sample 103 is harvested to the time it is processed as described herein may be reduced to ensure minimal morphological degradation such that resulting tissue sections are stable for at least 1 month at 4 ° Celsius.

The raw tissue sample 103 is subjected to raw tissue sectioning 106 to cut the raw tissue sample 103 into tissue samples 109 for further processing. The tissue samples 109 are cut so that a resulting tissue sample 109 comprises at least one dimension that is less than 5 millimeters. The tissue sample 109 may be a slice with a maximum thickness T of approximately 5 millimeters or less, where the thickness T of the slice comprises the dimension that is 5 millimeters or less. For example, the tissue samples 109 can be cut or sliced so that the resulting tissue sample 109 comprises at least one dimension that is less than 2 millimeters.

Alternatively, the raw tissue sample 103 may be separated into sections having at least one dimension that is greater than 1 millimeter given adjustments to the procedure as will be described.

In addition, given that the tissue sample 109 results from slicing the raw tissue sample 103, the tissue sample 109 is also subjected to the fixative such as 4% paraformaldehyde (PFA), glutaraldehyde, or other fixative as mentioned above.

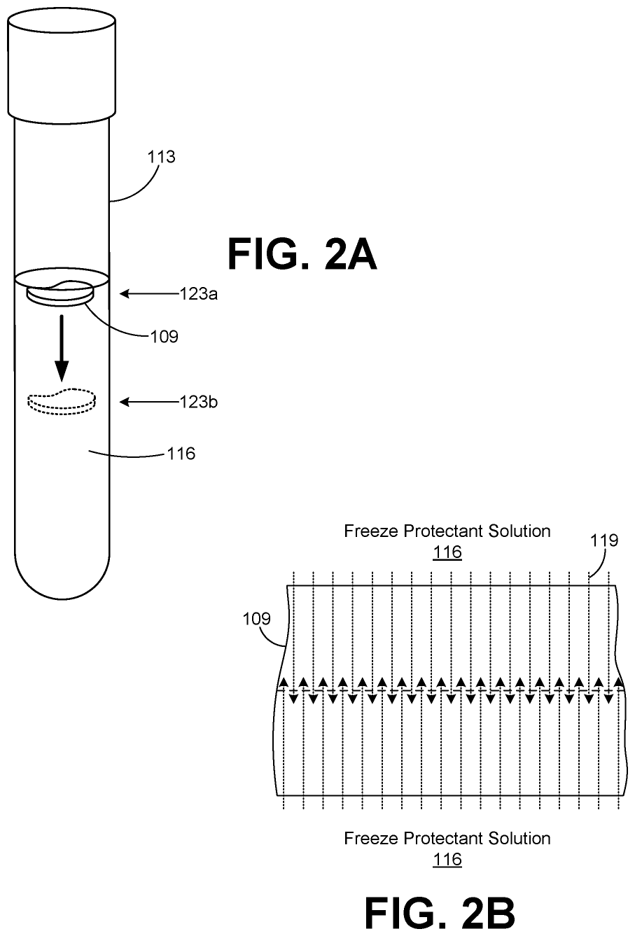

Referring next to FIGS. 2A and 2B, shown is a vessel 113 that contains an amount of solution that includes a predefined concentration of freeze protectant. The freeze protectant within the solution may comprise, for example, sucrose, glycerol, or another appropriate freeze protectant. A solution that includes a predefined concentration of freeze protectant is referred to herein as freeze protectant solution 116.

In a case where the freeze protectant comprises sucrose, the corresponding freeze protectant solution 116 may have a concentration of sucrose within a range having a lower limit of 60% up to the point of saturation, where the concentration of sucrose is approximately 79% or 2.3 Molar. That is to say, the freeze protectant solution 116 may have a concentration of sucrose that ranges from 60% to a point of a maximum concentration possible up to a point of saturation of the freeze protectant solution 116 with sucrose, which is approximately 2.3 Molar sucrose. As an additional alternative, the concentration of sucrose in the freeze protectant solution 116 may be greater than or equal to 60%. In one specific example, the concentration of sucrose in the corresponding freeze protectant solution 116 comprises substantially 79% or 2.3 Molar where the concentration may vary by 1% below saturation.

If other freeze protectants are used, then the concentration of such freeze protectants in the respective freeze protectant solutions 116 may be determined by way of an iterative process to achieve a minimum of freeze damage to the tissue sample 109.

In one example, the concentration of freeze protectant in an example of freeze protectant solution 116 may be a predefined concentration that prevents creation of one or more freeze damage artifacts that are greater than 10 nanometers in at least one dimension in the tissue sample 109. For example, such freeze damage artifacts may comprise a gap of at least 10 nanometers in the tissue sample 109 formed due to the expansion of water as the tissue sample 109 is frozen. Without freeze protection as set forth herein, intracellular water may form hexagonal ice crystals that expand in volume and ultimately distort membranes and organelles forming “holes” that destroy cell ultrastructure.

Also note that the solvent in the freeze protectant solution 116 may be water, phosphate buffered saline (PBS), or other liquid.

Once a tissue sample 109 has been obtained by slicing or otherwise dividing the raw tissue sample 103 (FIG. 1), the tissue sample 109 can then be soaked or submerged in the freeze protectant solution 116 for a predefined period of time to facilitate a predefined level of infiltration 119 of the freeze protectant solution 116 into the tissue sample 109. In one example, the predefined period of time is specified so that the infiltration 119 of the freeze protectant solution 116 is a full infiltration 119 as will be described below. Such predefined period of time may comprise, for example, 24 hours or other period of time to cause the desired infiltration 119 as may be indicated by the tissue sample 109 sinking in the freeze protectant solution 116 as will be described further below.

Once the tissue sample 109 is placed in the freeze protectant solution 116 in the vessel 113, the freeze protectant solution 116 is maintained at a temperature of approximately 4° Celsius to help preserve the tissue sample 109 during the process of infiltration of the freeze protectant solution 116 into the tissue sample 109. This may be accomplished by placing the vessel 113 containing the freeze protectant solution 116 and the tissue sample 109 into a refrigerator that is set for 4° Celsius. Alternatively, the freeze protectant solution 116 and the tissue sample 109 may be maintained at a temperature other than approximately 4° Celsius such as any temperature within the range of 4 ° Celsius to 25° Celsius provided that such temperature provides for adequate preservation of the tissue sample 109 during the process of infiltration 119 of the freeze protectant into the tissue sample 109. In one example, it is noted that small tissue pieces measuring 1 cubic millimeter can be infiltrated within 1 hour at room temperature.

As contemplated herein, it is understood that a refrigerator set at 4° Celsius may vary within a predefined tolerance of plus or minus up to 3° Celsius, where 4° Celsius is a target temperature. Accordingly, for all temperature targets stated herein, it is understood that each such temperature target may vary within an acceptable predefined tolerance of, for example, plus or minus 3° Celsius. However, to minimize the possibility that freeze damage artifacts are formed in the tissue sample 109, the temperature at which the vessel 113 containing the freeze protectant solution 116 and the tissue sample 109 can be maintained above freezing or 0° Celsius.

FIG. 2B shows a portion of the tissue sample 109 that illustrates the infiltration 119 of the freeze protectant solution 116 into the tissue sample 109. As contemplated herein, the infiltration 119 of the freeze protectant solution 116 includes the diffusion of the freeze protectant into the tissue sample 109. Also, as the freeze protectant solution 116 infiltrates into the tissue sample 109, it is understood that the freeze protectant in the freeze protectant solution 116 also infiltrates the tissue sample 109.

In one example, a period of time in which the tissue sample 109 is soaked in the freeze protectant solution 116 is such that the infiltration 119 of the freeze protectant solution 116 into the tissue sample 109 is full or complete infiltration such that the freeze protectant solution 116 infiltrates all regions or volumes of the tissue sample 109 that can be infiltrated. This reflects the fact that there may be some elements of a given tissue sample 109 that cannot be infiltrated.

In one example, a degree of infiltration 119 of the freeze protectant into the tissue sample 109 may be deemed adequate when the tissue sample 109 sinks into the freeze protectant solution 116 below an initial floating level 123a (FIG. 2A) to a lower floating level 123b (FIG. 2B). In this respect, the tissue sample 109 may be suspended in the middle of the freeze protectant solution 116. The sinking of the tissue sample 109 below the initial floating level 123a reflects the fact that the infiltration 119 has reached such a point that the buoyancy of the tissue sample 109 in the freeze protectant solution 116 is reduced given that the tissue infiltrated with sucrose solution is heavier than the sucrose solution, thereby causing the tissue sample 109 to sink in the freeze protectant solution 116. Accordingly, in one example, the tissue sample 109 is soaked at least until the tissue sample 109 sinks below the initial floating level 123a in the freeze protectant solution 116. A specific sinking threshold may be established where the tissue sample 109 is deemed adequately infiltrated when the tissue sample 109 sinks below such threshold. In another example, the soaking of the tissue sample 109 is performed until the tissue sample 109 sinks to the bottom of the vessel 113, thereby indicating that full infiltration has occurred. For many tissue samples 109, this may be accomplished by soaking the tissue sample 109 for 24 hours.

As an additional alternative, the tissue sample 109 is soaked in the freeze protectant solution 116 for a predefined period of time, thereby resulting in a predefined degree of infiltration 119 that may be less than a full or complete infiltration 119 if such degree of infiltration 119 is adequate to protect the tissue sample 109 from freeze damage as will be described. The period of time specified for the soaking of a tissue sample 109 in freeze protectant solution 116 may be determined by an iterative process and is affected by the size of the tissue sample 109 and the type of tissue that makes up the tissue sample 109.

Further, the period of time that a tissue sample 109 is soaked in the freeze protectant solution 116 may be specified based on a maximum thickness T of the tissue sample 109 (FIG. 1) in one dimension. That is to say, a maximum thickness T of given tissue sample 109 may vary. The period of time that a tissue sample 109 is soaked in the freeze protectant solution 116 may vary depending on the actual thickness T of the tissue sample 109.

For example, if the thickness T of the tissue sample 109 is 2 millimeters or less, the period of time that the tissue sample 109 is soaked in the freeze protectant solution 116 with a concentration of, for example, 79% sucrose or a concentration just before saturation, may be at least 60 minutes. Ultimately, the period of time that a tissue sample 109 is soaked in the freeze protectant solution 116 is specified to achieve a predefined degree of infiltration 119. Ultimately, the period of time a tissue sample 109 is soaked in a given freeze protectant solution 116 of a given formulation to achieve the desired infiltration 119 of freeze protectant solution 116 into the tissue sample may be determined by way of an iterative process.

As mentioned above, the tissue sample 109 is cut from the raw tissue sample 103. To achieve a full or complete infiltration 119 of the freeze protectant solution 116 into the tissue sample 109, the smallest width or thickness of the tissue sample 109 in a single dimension cannot be too great such that the freeze protectant solution 116 is prevented from infiltrating through to the center of the tissue sample 109. Thus, when slicing the raw tissue sample 103, care is taken to ensure that the maximum width or thickness in one dimension is not so large as to prevent a desired infiltration 119 of the tissue sample 109. In one example, the slicing of the raw tissue sample 103 results in slices of tissue samples 109 that are up to 5 millimeters.

In addition, as mentioned above, when subjecting the raw tissue sample, 103 to the chemical fixative to promote morphological preservation, a light fixation is used as mentioned above. The light fixation is performed, for example, to preserve tissue structure and antigens for immunohistochemistry. According to one example, the percent concentration of the fixative is specified so that the fixative that infiltrates the raw tissue sample 103, and the tissue sample 109 as part of the raw tissue sample 103, does not interfere with the infiltration 119 of the freeze protectant solution 116 and the corresponding freeze protectant into the tissue sample 109. Examples of a light fixative are set forth above.

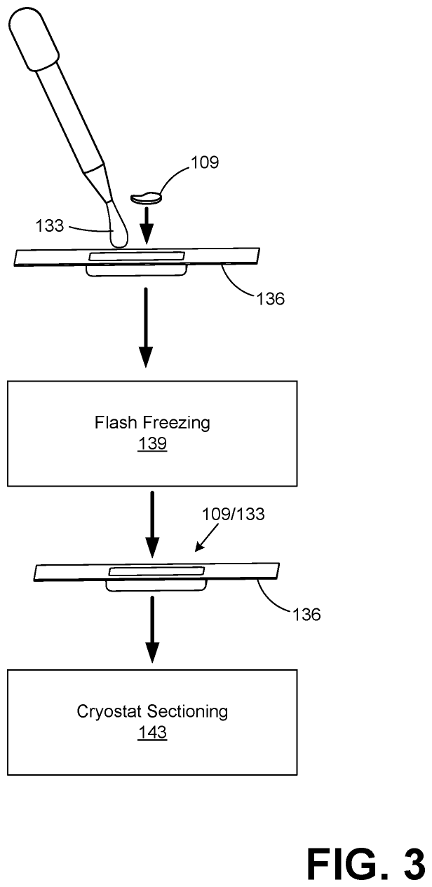

With reference to FIG. 3, once the tissue sample 109 has been soaked for the required period of time such that the freeze protectant solution 116 and the freeze protectant have infiltrated the tissue sample 109 in accordance with the specifications set forth above, next the tissue sample 109 is placed in a bath of Optimal Cutting Temperature (OCT) compound 133 in a mold 136 that is compatible with a given cryostat. In doing so, the tissue sample 109 is suspended in the OCT compound 133 in the mold 136.

Thereafter, the mold 136 containing the OCT compound 133 and the tissue sample 109 is subjected to flash freezing 139, for example, by submerging the same in liquid nitrogen. Due to the fact that the freeze protectant has infiltrated the tissue sample 109 as described above, any damage to the morphology of the tissue sample 109 is minimized or prevented. Such damage might typically occur due to the expansion of water during freezing. Freezing damage is particularly visible on a nanometer scale when using an electron microscope or other such high-resolution imaging technologies. To the extent that damage occurs, in one example such damage is below a threshold so that sections may be obtained from the tissue sample 109 that are ultimately suitable for electron microscopy or other high resolution imaging technologies.

Thereafter, cryostat sectioning 143 is performed on the mold 136 with the frozen OCT compound 133 and the tissue sample 109 in a suitable cryostat to produce one or more cryostat tissue sections while preserving the ultrastructural detail. Such a cryostat may comprise, for example, a Leica Cryostat model CM3050S manufactured by Leica Biosystems headquartered in Nussloch, Germany. The cutting temperature of the cryostat may be, for example, in a range of −35° Celsius to −45° Celsius and the resulting cryostat tissue sections may comprise slices of the tissue sample 109 with a thickness that falls, for example, within a range of 2 to 10 micrometers.

In order to ensure that the resulting cryostat tissue sections are suitable for electron microscopy and other similar purposes, care is taken to minimize sectioning artifacts when slicing the tissue sample 109 into cryostat tissue sections. According to one example, a knife angle setting of a cryostat is specified as 5 degrees.

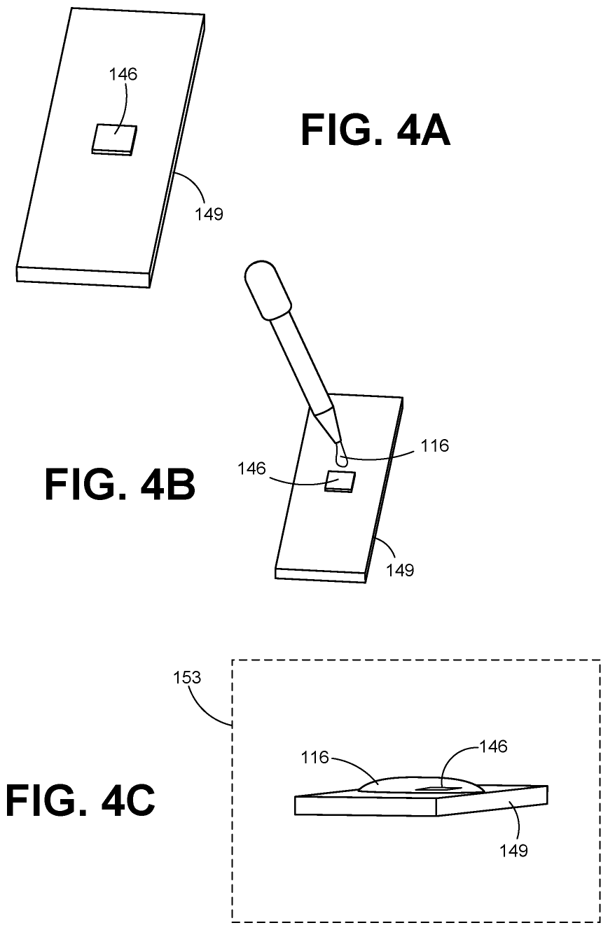

Referring next to FIG. 4A, once a cryostat tissue section 146 has been produced by virtue of the cryostat sectioning 143 as described above, next such cryostat tissue section 146 is mounted onto a slide 149. The slide 149 may be gold plated, or other type of slide. In one example the slide 149 may be Superfrost Plus Gold Microscope Slides manufactured by Thermo Fisher Scientific of Waltham, Massachusetts.

Then, as shown in FIG. 4B, the cryostat tissue section 146 is covered on the slide 149 with an amount of the freeze protectant solution 116 as soon as possible after the cryostat tissue section 146 adheres to the slide 149. The freeze protectant solution 116 is placed onto the cryostat tissue section 146 on the slide 149 in a manner such that the freeze protectant solution 116 completely covers the cryostat tissue section 146. Thereafter, as shown in FIG. 4C, the next task is to store the slide 149 with the cryostat tissue section 146 covered by or submerged in the freeze protectant solution 116 in a refrigerator 153.

With reference to FIGS. 4A, 4B, and 4C, the mounting of the cryostat tissue section 146 to the slide 149 and the application of the freeze protectant solution 116 is performed as quickly as possible after the cryostat tissue section 146 is sliced from the tissue sample 109 to minimize any drying that may occur to the cryostat tissue section 146. Adsorption may occur from 10 seconds to 120 seconds depending on the thickness of the cryostat tissue section 146. If multiple cryostat tissue sections 146 are produced, then multiple slides 149 may be needed for the mounting of the individual cryostat tissue sections 146. A cryostat tissue section 146 is mounted on the slide 149 in a manner so as to adhere to the slide 149 as can be appreciated.

In one example, the mounting of a cryostat tissue section 146 onto the slide 149 and the covering of the cryostat tissue section 146 with the freeze protectant solution 116 is performed within a time period of a few seconds after the cryostat tissue section 146 is available for mounting from the cryostat. In one example, this time period may be 10 seconds or less for cryostat tissue sections 146 of 2 um thickness or more. In another example, this time period may be up to 120 seconds for cryostat tissue sections 146 having a thickness of 10 um thickness or more. A good indicator for adsorption of a cryostat tissue section 146 without completely drying out is if the Optimal Cutting Temperature (OCT) compound that surrounds the cryostat tissue section 146 turns opaque.

In another example, the time period is specified so that drying is minimal such that the morphology of the cryostat tissue section 146 is substantially preserved for purposes of viewing under an electron microscope or other devices that can view an item at a resolution of less than 200 nanometers. That is to say, the time period beginning at a first time when the cryostat tissue section 146 is mounted onto the slide 149 and ending at a second time when the freeze protectant solution 116 covers the cryostat tissue section 146 is short enough to prevent drying of the cryostat tissue section 146, thereby preserving a morphology of the cryostat tissue section.

According to one example, the cryostat sectioning of the tissue sample 109 produces cryostat tissue sections 146 having a cross-sectional area of the cryostat tissue sections 146 that can be greater than 1 square millimeter. Specifically, the cross-sectional area of the cryostat tissue sections 146 in terms of square millimeters may be greater than, for example, 1 mm², 2 mm², 3 mm², 4 mm², 5 mm², or 6 mm², 10 mm², 15 mm², 20 mm², 25 mm² , or higher. Such cross-sectional areas are termed “wide scale” herein as they are greater than 1 mm² . Such wide scale cross-sectional areas allow target tissue samples to be viewed to find target structures or areas, where tissue samples that are below 1 mm² are generally difficult to view using, for example, electron microscopy on a scale of 200 nanometers or below due to the fact that certain structures within tissue samples that one wishes to view may not be captured in such a tissue sample having such a small cross-sectional area.

In addition, the refrigerator 153 may be set to maintain each slide 149, cryostat tissue section 146, and the amount of freeze protectant solution 116 covering the cryostat tissue section 146 at 4° Celsius. Alternatively, the freeze protectant solution 116 and the tissue sample 109 may be maintained at a temperature other than approximately 4° Celsius such as any temperature within the range of 4-10° Celsius provided that such temperature provides for adequate preservation of the cryostat tissue section 146 for future use. Also, as contemplated herein, it is possible that the temperature inside the refrigerator 153 may vary over time, where the 4° Celsius comprises on example of a target temperature.

The slide 149 that includes the cryostat tissue section 146 covered by or submerged in the freeze protectant solution 116 may be stored in the refrigerator 153 at around 4° Celsius for up to 2 months, where the refrigerator may ultimately fluctuate between 2° Celsius and 6° Celsius. Alternatively, the storage can be any time period within which the morphology of the cryostat tissue section 146 is adequately preserved. By virtue of the fact that the cryostat tissue section 146 is covered or submerged in the freeze protectant solution 116 on the slide 149, the cryostat tissue section 146 is prevented from drying by the freeze protectant solution 116 during storage in the refrigerated compartment.

In addition, the process described herein that includes the soaking of the tissue sample 109, freezing of the tissue sample 109, performing the cryostat sectioning on the tissue sample 109 to create one or more cryostat tissue sections 146, mounting a cryostat tissue section 146 onto the slide 149, and covering the cryostat tissue section 146 with the freeze protectant solution 116 are performed without an intervening step that results in a drying of the tissue sample 109 or the cryostat tissue section 146. For example, during the process no deliberate action is taken that would result in drying of the tissue sample 109 or the cryostat tissue section 146. Stated further, neither the tissue sample 109 nor the cryostat tissue section 146 are exposed to acetone or other solution that would promote drying. Also, no deliberate step is taken such as allowing the tissue sample 109 or the cryostat tissue section 146 to stand in ambient air for more time than is necessary to cause the cryostat tissue section 146 to adhere to the slide 149 as described above.

At resolutions of 200 nanometers or less, very small variations in the structural details of a tissue sample look very large. Also, very small artifacts caused by damage to tissue samples due to freezing or drying can be very significant such that such tissue samples are not suitable for applications that operate at a resolution of below 200 nanometers. The processes described herein to result in cryostat tissue sections 146 that retain ultrastructural morphology on a nanometer scale such that the tissue in the cryostat tissue sections 146 is suitable for viewing on a system having a resolution below 200 nanometers over a relatively wide-field area.

As such, the cryostat tissue sections 146 are suitable for further processing for several different purposes including, for example, electron microscopy morphology (morphology EM), immunogold electron microscopy (immuno-EM), correlated immunofluorescence and immunogold electron microscopy (also known as correlative light and electron microscopy (CLEM)), energy dispersive X-ray (EDX) (also known as X-ray Energy Dispersive Spectroscopy (XEDS), or other high resolution applications.

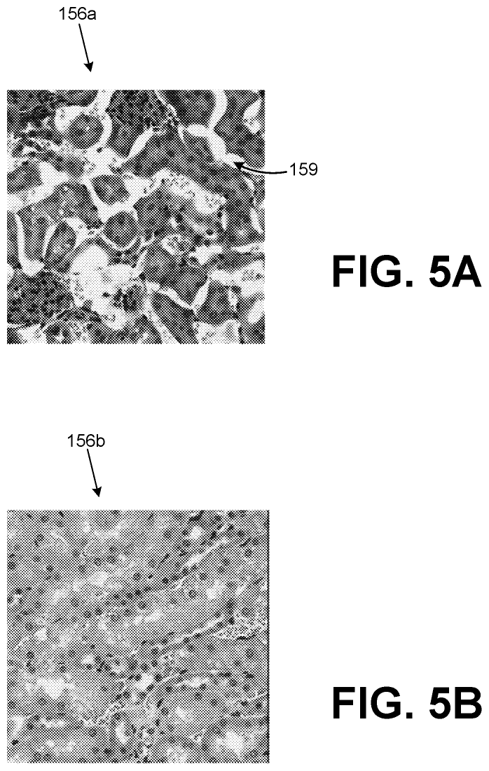

With reference to FIGS. 5A and 5B, shown are examples of human kidney tissue 156a and 156b. The specific tissue sections depicted were magnified by 200X (optical microscope setting) and the image size is 200 micrometers by 200 micrometers or 40,000 square micrometers.

The tissue section depicted in FIG. 5A was taken from a tissue sample that was soaked in a 20% concentration of freeze protectant solution that included 20% sucrose. The tissue section depicted in FIG. 5B was taken from a tissue sample that was soaked in a 79% concentration of freeze protectant solution (nearly saturated) as described above. As shown, the tissue section depicted in FIG. 5A includes freeze damage artifacts 159 comprising gaps between tissue elements due to the expansion of water during freezing. However, the tissue section depicted in FIG. 5B does not show similar freeze damage artifacts 159.

Thus, the cryostat tissue sections 146 (FIG. 4A) provide a significant advantage in that they make possible wide scale tissue samples that are acceptable for electron microscopy or other high resolution imaging technologies. In addition, the cryostat tissue sections 146 also facilitate various applications such as immunofluorescence confocal microscopy, immunofluorescence super-resolution microscopy, immunofluorescence expansion microscopy, oriented morphology electron microscopy correlated with a parallel Hematoxylin and eosin (H & E) stained cryostat sections, Immunogold Electron Microscopy (immune-EM), Correlated Immunofluorescence Electron Microscopy (CLEM), and potentially other applications.

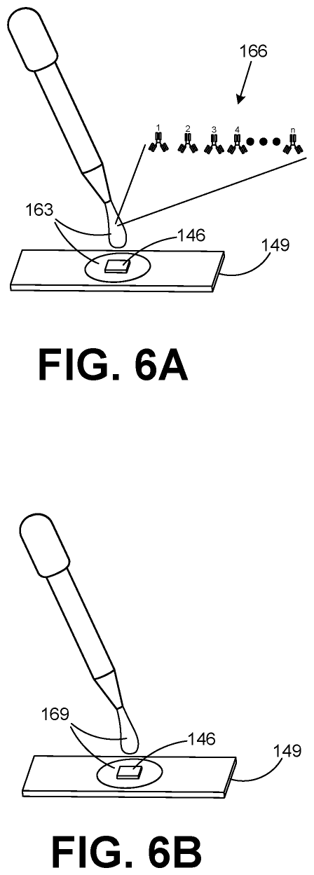

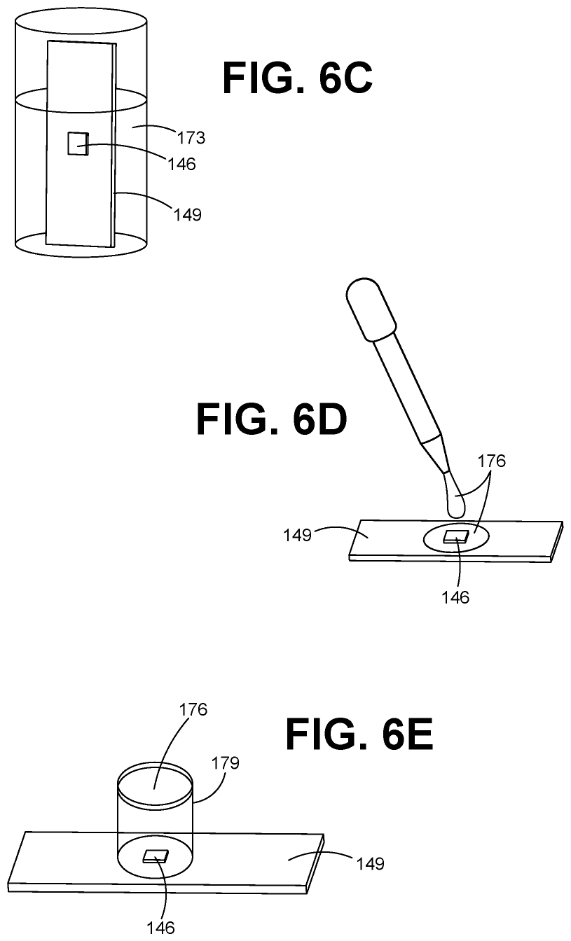

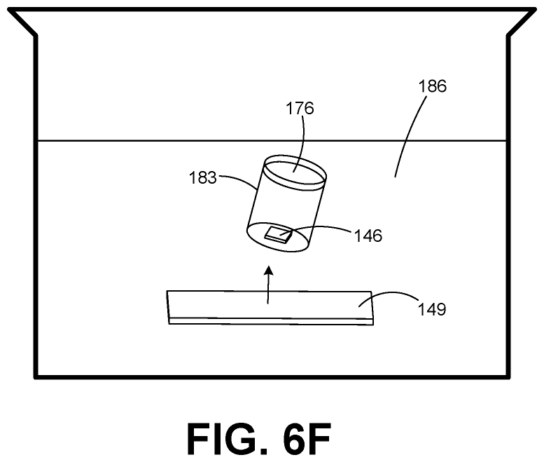

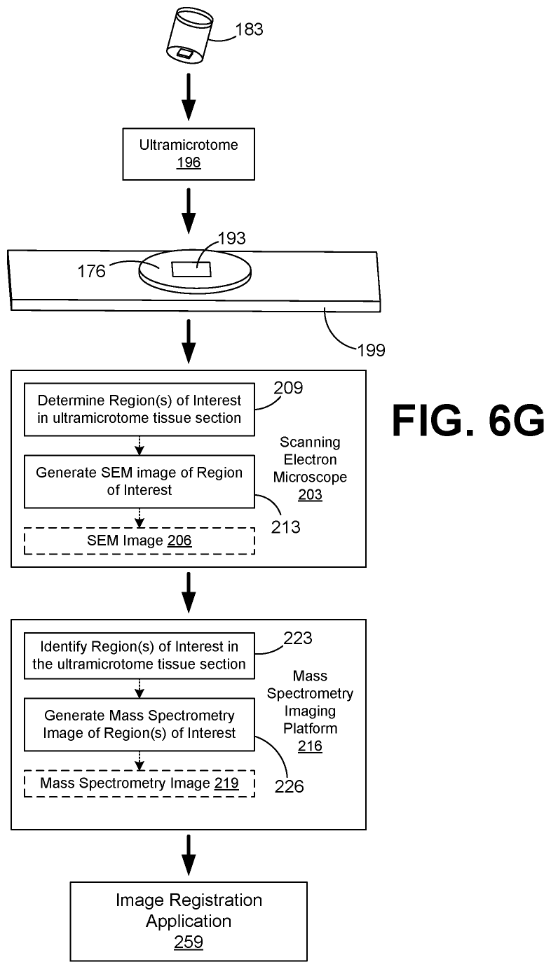

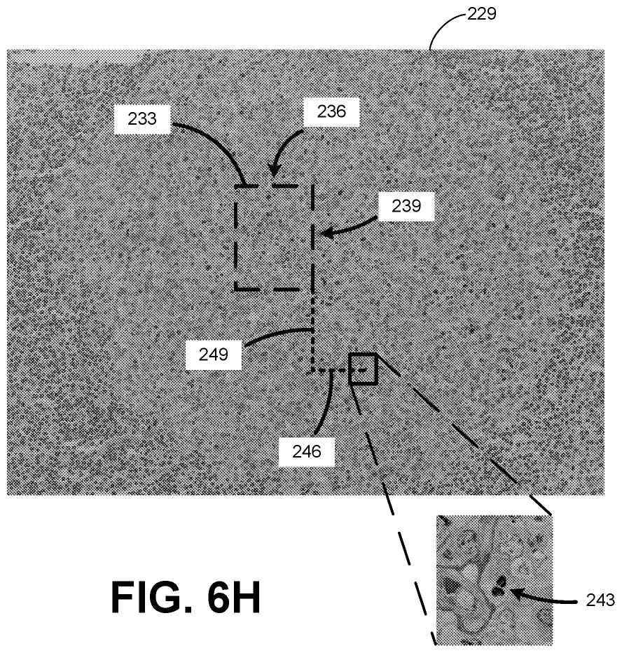

Referring next to FIG. 6A, shown is an illustration of a pre-embedding labeling of cryostat tissue section 146 (FIG. 4A) using a cocktail 163 of metal-conjugated antibodies 166 and other elements.

To pre-embed the cryostat tissue section 146, first the cryostat tissue section 146 is washed for 15 minutes relative time (RT) in Phosphate Buffered Saline (PBS) and then permeabilized for 20 minutes RT in 0.5% saponin. The cryostat tissue section 146 is then pre-blocked for 30 minutes RT in blocking solution with 1% BSAc™, which is a trademark of Aurion Biotech of Seattle, Washington. As shown in FIG. 6A, an amount of the cocktail 163 is then placed onto the cryostat tissue section 146 using a dropper. The slide 149 with the cryostat tissue section 146 covered in the solution that makes up the cocktail 163 is placed in a wet chamber and incubated for approximately 96 hours at a temperature of approximately 4° C., although the temperature may vary as described above. In this manner, the cryostat tissue section 146 is soaked in the cocktail 163 to allow the metal-conjugated antibodies 166 to attach to the respective receptors or other elements in the cryostat tissue section 146. In this respect, the metal-conjugated antibodies 166 may target specific elements in the cryostat tissue section 146.

The cocktail 163 of metal-conjugated antibodies 166 is created for purposes of tissue staining to label various elements of a sample of tissue such as the cryostat tissue section 146. The metal-conjugated antibodies 166 may be considered markers that are directed to specific structures in a sample of tissue. The cocktail 163 may include, for example, 10 ug/ml of each metal-conjugated antibody 166. The metal-conjugated antibodies 166 may be generated according to an Ionpath Multiplex Ion Beam Imaging tag (MIBItag) protocol produced by Ionpath of Menlo Park, California. Alternatively, other labeling protocols may be used.

In one example, the cocktail 163 may comprise polymers of isotopically-purified lanthanide metals (e.g., 169 Tm) that are conjugated to reduced IgG antibodies (e.g., anti-CD20) using a maleamide-thiol reaction. In one case, up to 39 different metal-conjugated antibodies can be used simultaneously in the cocktail 163 given the availability of isotopically distinct MIBItags produced by Ionpath of Menlo Park, California. In such a case, the variable n shown in FIG. 6A would be 39. In one example, the cocktail 163 includes a diluent that comprises 3% Donkey Serum in 1x TBS IHC Wash Buffer plus TWEEN® produced by Sigma-Aldrich of St. Louis, Missouri, where TWEEN® is a registered Trademark of Sigma-Aldrich.

In another example, the cocktail 163 includes markers that target one or more discernible elements that exist in a tissue sample such as a cryostat tissue section 146. As contemplated herein, a discernible element is one that is distinct from other portions of the tissue sample such that it includes one or more features or boundaries that can be identified or recognized relative to other portions of the tissue sample.

When a given marker in the cocktail 163 targets one or more discernible elements in a tissue sample such as a cryostat tissue section 146 described above, the marker may increase a contrast between one or more discernible elements in a tissue sample such as cryostat tissue section 146 or other tissue sample as described herein. As such, a discernible element in a tissue sample is made more prominent or perceivable. Such a discernible element can aid in registration of two or more images of the same tissue sample as will be described. That is to say, registration, whether performed by landmark registration, whole slide registration, or any other registration application, is based on one or more such discernible elements.

In one example, the cocktail 163 includes a chromatin marker that targets chromatin such as, for example, Deoxyribonucleic acid (DNA) of a nucleus, Ribonucleic acid (RNA), and/or other elements. Such a chromatin marker targeting the chromatin in a given tissue sample may increase the contrast between the chromatin in the tissue sample and other portions of the tissue sample. In this respect, the discernible element may comprise the chromatin elements.

In another example, the cocktail 163 includes a membrane marker that targets membranes of cells and other tissue in a tissue sample. A membrane marker targeting a membrane in a given tissue sample increases the contrast between the membrane in the tissue sample and other portions of the tissue sample. In this respect, the discernible element may comprise such membranes of cells.

By increasing the contrast between discernible elements such as chromatin or a membrane in a tissue sample, such discernable elements may aid in registration of multiple images of such tissue sample taken using different imaging platforms as will be described.

Thus, to provide one specific example, a tissue sample comprising the cryostat tissue section 146 is soaked in a cocktail 163 that comprises a solution that includes a chromatin marker before performing an ultramicrotome sectioning of the tissue sample to produce one or more ultramicrotome tissue sections as will be described. Such a chromatin marker increases a contrast between a chromatin element in the ultramicrotome tissue sample targeted by the chromatin marker and another portion of the ultramicrotome tissue sample.

In another specific example, a tissue sample comprising the cryostat tissue section 146 is soaked in a cocktail 163 that comprises a solution that includes a membrane marker before performing an ultramicrotome sectioning of the tissue sample to produce one or more ultramicrotome tissue sections as will be described. Such a membrane marker increases a contrast between a membrane in the ultramicrotome tissue sample targeted by the membrane marker and another portion of the ultramicrotome tissue sample.

With reference to FIG. 6B, once the incubation of the cryostat tissue section 146 in the cocktail 163 on the slide 149 has completed, the cryostat tissue section 146 is washed 4 times for 30 minutes RT in PBS with 0.1% BSAc. The cryostat tissue section 146 is then rinsed in purified water and fixed in ½ Karnovsky's fixative 169 in a wet chamber for 24 hours at a temperature of approximately 4° C. in order to preserve the ultrastructural tissue morphology for purposes of electron microscopy and other high resolution imaging.

The antibody-labeled and fixed cryostat tissue section 146 is then stained for 1 hour RT in a 2% aqueous osmium tetroxide solution followed by a staining in 0.5% aqueous uranyl acetate for 1 hour RT.

With reference to FIG. 6C, the cryostat tissue section 146 is dehydrated in an ascending series of ethanol and acetone 173. Thereafter, as depicted in FIG. 6D, the cryostat tissue section 146 is flat embedded in an epoxy resin 176 such as Embed 812 manufactured by Electron Microscope Science of Hatfield, Pennsylvania. As shown in FIG. 6D, the cryostat tissue section 146 on the slide 149 is first covered in the epoxy resin 176, for example, with a dropper. Thereafter, as shown in FIG. 6E, a resin filled BEEM® capsule 179 is placed over the cryostat tissue section 146 on the slide 149. BEEM® is a registered trademark of Ted Pella, Inc. of Redding, California. Polymerization occurs at a temperature of approximately 65° C. for at least 2 days.

Referring next to FIG. 6F, the block 183 that comprises the hardened epoxy resin 176 with the embedded cryostat tissue section 146 is separated from the slide 149. This is accomplished by placing the slide 149 and the block 183 in a bath of liquid nitrogen 186 to cause the block 183 with the cryostat tissue section 146 to “pop off” the slide 149 due to the differential in thermal shrinkage and expansion of the epoxy resin 176 versus the slide 149.

With reference to FIG. 6G, shown is the further processing of the cryostat tissue section 146 embedded in the block 183 of hardened epoxy resin 176. Specifically, the block 183 is trimmed as appropriate and cut into one or more ultramicrotome tissue sections 193 using an ultramicrotome 196. An example of such an ultramicrotome 196 would be a Leica UC7 Ultramicrotome that employs, for example, a DIATOME® diamond histoknife manufactured by Ted Pella, Inc. of Redding, California. DIATOME® is a registered trademark of Ted Pella, Inc. of Redding, California. In one example, the ultramicrotome 196 used produces one or more ultramicrotome tissue sections 193 that comprise slices that are, for example, 500 nm to 1 um thick. Each ultramicrotome tissue section 193 is embedded in the slide of hardened epoxy resin 176.

The ultramicrotome tissue section 193 taken from the tissue sample that comprises the cryostat tissue section 146 may be as large in terms of cross-sectional area as the cryostat tissue section 146. In one example, the ultramicrotome tissue section 193 is of a “wide scale” in that the ultramicrotome tissue section 193 has a cross sectional area that is greater than 1 square millimeter (mm 2). Alternatively, the ultramicrotome tissue section 193 may have a cross-sectional area that is greater than any number that falls within the range of 1 mm² through 25 mm². For example, the ultramicrotome tissue section 193 may have a cross-sectional area that is greater than 1 mm², 2 mm², 3 mm², 4 mm², 5 mm², 6 mm² , and so on.

In one example, the cocktail 163 (FIG. 6A) in which the cryostat tissue section 146 (FIG. 6A) is soaked as noted above includes a chromatin marker, a membrane marker, or other type of marker. Such a marker increases a contrast between a chromatin element, membrane element, or other discernible element in the ultramicrotome tissue section 193 that is targeted by the respective marker and another portion of the ultramicrotome tissue section 193.

A ultramicrotome tissue section 193 resulting from the sectioning by the ultramicrotome 196 is mounted on a slide 199. The slide 199 may comprise a gold and tantalum coated glass slide. Then, the ultramicrotome tissue section 193 is subjected to drying and counterstaining. The ultramicrotome tissue section 193 may be dried on a heat plate. The counterstaining involves bathing the ultramicrotome tissue section 193 in, for example, 2% aqueous uranyl acetate for 15 minutes and then bathing the ultramicrotome tissue section 193 twice in, for example, a 0.1% lead citrate for 30 seconds. After drying, the ultramicrotome tissue section 193 on a given slide 199 is positioned in a scanning electron microscope 203 to produce a scanning electron microscope image 206. In one example, the scanning electron microscope image 206 is an image of a portion of the ultramicrotome tissue section 193 of the tissue sample. The tissue sample may comprise, for example, the cryostat tissue section 146 (FIG. 4A) as described above.

The scanning electron microscope 203 may comprise, for example, a Zeiss GEMINI® 300 scanning electron microscope operating at, for example, 5 Kilo-electron volts using a BDS1 backscattered electron detector or equivalent. The Zeiss GEMINI® 300 scanning electron microscope is manufactured by Carl Zeiss Microscopy Deutschland Gmbh of Oberkochen, Germany. Also, GEMINI® is a registered trademark of Carl Zeiss Microscopy Deutschland Gmbh of Oberkochen, Germany.

To generate the scanning electron microscope image 206, in box 209 one or more regions of interest in the ultramicrotome tissue section 193 are identified. A region of interest is one in which one or more histological features are located within the ultramicrotome tissue section 193.

Referring to FIG. 6H, shown is an example of an image 229 of at least a portion of an ultramicrotome tissue section 193 (FIG. 6G) that can be generated by a scanning electron microscope image 206 (FIG. 6G). The image 229 depicted in FIG. 6H illustrates how a region of interest 233 may be specified.

The region of interest 233 comprises, for example, a rectangular region having a first side 236 of a first length and a second side 239 of a second length. Alternatively, a region of interest 233 may be identified using other shapes and location data. For example, a region of interest may be specified as a circle having a particular radius about a given center point.

The region of interest 233 is identified as having one or more histological features that may have significance to the extent that they indicate certain conditions such as disease or other conditions.

One or more discernable elements 243, also known as landmarks, may be identified in the view of the ultramicrotome tissue section 193. The location of a given region of interest 233 may be specified relative to the position of such discernable elements 243 in a given image. The position of one or more discernable elements 243, the unique shape of the one or more discernable elements 243, and the location of a given region of interest 233 relative to the one or more discernable elements 243 in a scanning electron microscope image 206 may be saved in memory so that a region of interest 233 may be identified using the mass spectrometry imaging platform 216 (FIG. 6G) to generate the mass spectrometry image 219 (FIG. 6G).

The one or more discernable elements 243 may be identified based on predefined criteria. In one example, a discernable element 243 may be identified due to the fact that a given marker such as a chromatin marker, membrane marker, or other type of marker may be concentrated at the site of a given discernable element 243. This may result in increased contrast between the respective discernable element 243 and the surrounding tissue making it more prominent and potentially easier to identify. A discernable element 243 may comprise, for example, membranes, chromatin, or other tissue elements.

In one example, a region of interest 233 may be identified in a view of ultramicrotome tissue section 193 as generated by a scanning electron microscope image 206. Also, certain discernable elements 243 may also be identified and the distance between each of the discernable elements 243 and a corner or other feature of the region of interest 233 may be determined. For example, as set forth in FIG. 6H, the distance between a respective discernable element 243 and a corner of a region of interest 233 may be specified as an x distance 246 and y distance 239. Alternatively, a distance set at an angle relative to an x or y axis may be specified, or some other positioning approach may be employed. As such, a region of interest 233 may be identified based on the location of one or more discernable elements 243 and a discernable feature of the region of interest 233. Given that the shape and size of the region of interest 233 are known, the region of interest 243 may be determined accordingly.

Referring back to FIG. 6G, in box 213, a scanning electron microscope image 206 is generated of the one or more regions of interest 243 (FIG. 6H) identified in box 209. The scanning electron microscope image 206 may be generated at the highest image resolution possible using the scanning electron microscope 203 or some other resolution. For example, the scanning electron microscope image 206 may be generated at a resolution that matches the resolution of the mass spectrometry imaging platform 216.

Next, the ultramicrotome tissue section 193 is imaged by a mass spectrometry imaging platform 216 to produce a mass spectrometry image 219. The mass spectrometry imaging platform 216 may be employed to generate a mass spectrometry image 219 that is a portion of the ultramicrotome tissue section 193. Such a portion of the ultramicrotome tissue section 193 is a region of interest that overlaps the region of interest 233 that was imaged by the scanning electron microscope 203.

The mass spectrometry imaging platform 216 may comprise, for example, a MIBIscope™ commercial platform produced by Ionpath of Menlo Park, California or equivalent. MIBISCOPE™ is a trademark of Ionpath of Menlo Park, California. In one example, the mass spectrometry image 219 depicts antibody labeling of elements in the ultramicrotome tissue section 193 of a tissue sample as was described above with reference to FIG. 6A. Such a tissue sample may comprise, for example, a cryostat tissue section 146 as described above.

Specifically, with respect to the mass spectrometry imaging platform 216, in box 223 one or more regions of interest 233 (FIG. 6H) are identified in the ultramicrotome tissue section 193 using the mass spectrometry imaging platform 216. The regions of interest 233 that are identified may overlap the region of interest 243 identified and imaged using the scanning electron microscope 203 as described above. The region of interest 233 determined in the mass spectrometry imaging platform 216 may be identified based on the previously stored data that identifies the discernable elements 243 and the location of the region of interest 243 relative to the location of such discernable elements 243. That is to say, such data may include variables that specify the distance between one or more discernable elements 243 and a feature of the region of interest 243 such as a corner noted above.

Next, in box 226, a mass spectrometry image 219 of one or more regions of interest 233 is generated and stored in memory.

Thereafter, an image registration application 259 is used to register the scanning electron microscope image 206 with the mass spectrometry image 219 as will be described.

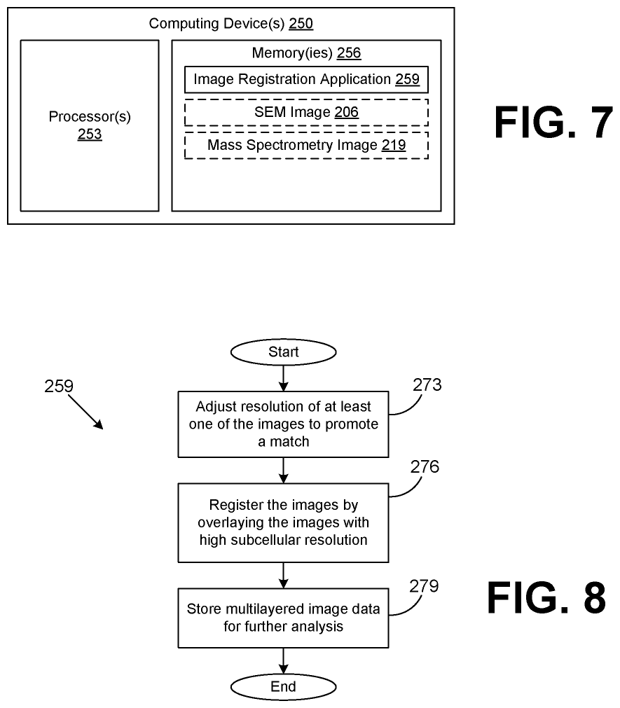

With reference to FIG. 7, shown is an example of a computing device 250 that may comprise, for example, a computer, a server computer or any other system providing computing capability.

Each computing device 250 may include one or more processor circuits having a processor 253 and associated memory 256. The memory 256 is defined herein as including both volatile and nonvolatile memory and data storage components. Volatile components are those that do not retain data values upon loss of power. Nonvolatile components are those that retain data upon a loss of power. Thus, the memory 256 may comprise, for example, random access memory (RAM), read-only memory (ROM), hard disk drives, solid-state drives, flash drives, memory cards, and/or other memory components, or a combination of any two or more of these memory components. In this respect, the various forms of the memory 256 are non-transitory computer-readable mediums.

Alternatively, the computing device 250 may be part of a computing environment that may employ a plurality of servers or other computing devices that may be arranged, for example, in one or more server banks or computer banks or other arrangements. Such computing devices may be located in a single installation or may be distributed among many different geographical locations. For example, such a computing environment may include a plurality of server computers that together may comprise a hosted computing resource, a grid computing resource and/or any other distributed computing arrangement. In some cases, such a computing environment may correspond to an elastic computing resource where the allotted capacity of processing, network, storage, or other computing-related resources may vary over time.

Stored in the memory 256 and executable by the one or more processor circuits is the image registration application 259. The image registration application 259 is executed to register the scanning electron microscope image 206 with the mass spectrometry image 219. Alternatively, the image registration application 259 may register portions of the scanning electron microscope image 206 with corresponding portions of the mass spectrometry image 219.

In addition, stored in the memory 256 and accessed or manipulated by the image registration application 259 as executed by the processor circuit is the scanning electron microscope image 206 and the mass spectrometry image 219. The scanning electron microscope image 206 depicts the ultramicrotome tissue section 193 (FIG. 6G) of a tissue sample such as the cryostat tissue section 146 (FIG. 6A), where the scanning electron microscope image 206 is generated using a scanning electron microscope 203 (FIG. 6G) as described above. The mass spectrometry image 219 depicts the same ultramicrotome tissue section 193 (FIG. 6G) from the same tissue sample such as the cryostat tissue section 146 (FIG. 6A), where the mass spectrometry image 219 is generated using a mass spectrometry imaging platform 216 (FIG. 6G).

Referring next to FIG. 8, shown is a flowchart that provides one example of the operation of a portion of the image registration application 259. It is understood that the flowchart of FIG. 8 provides merely an example of the many different types of functional arrangements or instructions that may be employed to implement the operation of the portion of the image registration application 259 as described herein. As an alternative, the flowchart of FIG. 8 may be viewed as depicting an example of elements or steps of a method implemented in the computing device 250 (FIG. 7). The instructions stored in the memory 256, when executed by a processor circuit of the computing device 250, cause the computing device 250 to perform the various functions set forth below.

Beginning with box 273, the image registration application 259 accesses the scanning electron microscope image 206 and the mass spectrometry image 219 in the memory and, if necessary, adjusts a resolution of at least one of the images 206/219 to ensure that the resolution of both images 206/219 is the same for purposes of registration. For example, the image registration application 259 may adjust a resolution of the mass spectrometry image 219 to match a resolution of the scanning electron microscope image 206. Alternatively, the image registration application 259 may adjust a resolution of the scanning electron microscope image 206 to match a resolution of the mass spectrometry image 219.

Thereafter, in box 276, the image registration application 259 registers the scanning electron microscope image 206 with the mass spectrometry image 219. In doing so, the mass spectrometry image 219 with the scanning electron microscope image 206 are overlayed with high resolution such that subcellular resolution is achieved. In one example, the registration may be conducted using a landmark registration by executing a landmark registration application in Matlab®, which is a product of Mathworks® of Natick, Massachusetts, or other appropriate registration application. Alternatively, the registration may be conducted using a “whole slide registration” such as, for example, WSIreg licensed by the Massachusetts Institute of Technology of Cambridge, Massachusetts. In addition, other registration applications may be employed to register the scanning electron microscope image 206 with the mass spectrometry image 219.

Various ones of the metal-conjugated antibodies 166 (FIG. 6A) may comprise a marker that increases a contrast between a discernible element in an ultramicrotome tissue section 193 that is targeted by the marker and another portion of the ultramicrotome tissue section 193. Such a marker may comprise, for example, a chromatin marker, a membrane marker, or another type of marker. Such discernible elements have an increased contrast with respect to other portions of the ultramicrotome tissue section 193 as described above.

Also, as mentioned above, the ultramicrotome tissue section 193 is of a “wide scale” in that the ultramicrotome tissue section 193 has a cross sectional area that is greater than 1 square millimeter (mm²). Alternatively, the ultramicrotome tissue section 193 may have a cross-sectional area that is greater than any number that falls within the range of 1 mm² through 25 mm². In some cases, the ultramicrotome tissue section 193 may have a cross-sectional area that is greater than 25 mm² . For example, the ultramicrotome tissue section 193 may have a cross-sectional area that is greater than 1 mm², 2 mm², 3 mm², 4 mm², 5 mm², 6 mm², and so on.

Next, in box 279 the overlayed and correlated image data that comprises both the scanning electron microscope image 206 and the mass spectrometry image 219 is stored in the memory 256 for further analysis. In one example, the scanning electron microscope image 206 is added as a layer to a multilayer image generated by the mass spectrometry imaging platform 216 (FIG. 6G). In this respect, a color representing each type of marker employed may be stored as a channel or layer in a multilayer image, where the scanning electron microscope image 206 is added thereto as a further layer or channel. Such a multilayer image may allow different layers to be switched on and off depending on the information sought from the multilayer image. Thereafter, the execution of the image registration application 259 ends as shown.

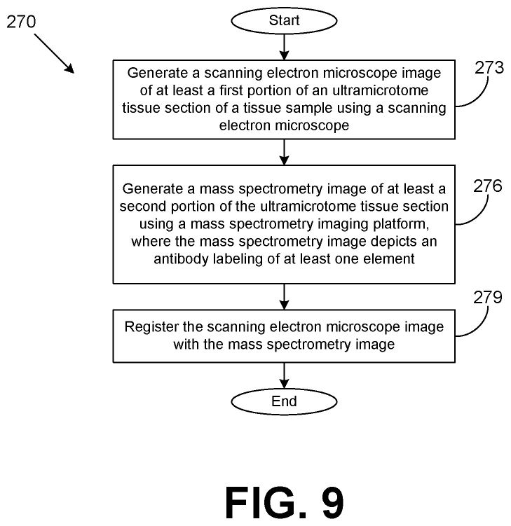

With reference to FIG. 9, shown is a flow chart of one example method 270 of the present disclosure. The method 270 depicted in FIG. 9 provides for one or more advantages or benefits including the creation of “wide scale” scanning electron microscope images 206 (FIG. 6G) and “wide scale” mass spectrometry images 219 (FIG. 6G). In a further advantage, the scanning electron microscope images 206 can be registered with the corresponding mass spectrometry images 219 to provide significant information about the morphology of tissue samples.

As described above, freeze damage is minimized or prevented on such wide scale tissue samples 109 so that they are suitable for ultramicrotome sectioning, thereby producing ultramicrotome tissue sections 193 (FIG. 6G) that are suitable for high resolution imaging such as electron microscopy or other high resolution imaging technologies. The methods described herein for preparing the cryostat tissue sections 146 (FIG. 4A) make them suitable for ultramicrotome sectioning to produce the “wide scale” ultramicrotome tissue sections 193 that experience minimal damage due to freezing, drying, and other handling such that the ultramicrotome tissue sections 193 are suitable for electron microscopy and multiplex ion beam imaging combined with electron microscopy. Such ultramicrotome tissue sections 193 are “wide scale” in that they have a cross-sectional area that is larger than one or more square millimeters.

The fact that ultramicrotome tissue sections 193 can be produced at such sizes facilitates a much greater view of the morphology of tissue samples. Also, when such wide scale cryostat tissue sections 146 are subjected to pre-embedding of markers such as metal-conjugated antibodies 166 (FIG. 6A), stains, dyes, and other markers, the resulting ultramicrotome tissue sections 193 reveal significantly more information about the tissue morphology when registering scanning electron microscope images 206 with corresponding mass spectrometry images 219. For example, immunogold EM can provide information about the location of antigens or therapeutic molecules of interest within highly resolved structural context without restricting the number of localized antigens to 1-3 that can be imaged within an ultra-structural context. As described herein, multiplexed antigen detection for electron microscopy is facilitated with a relatively large number of localized antigens while maximizing the area of a section that can be viewed by way of electron microscopy where the ultrastructure is preserved over the relatively wide field of view. This provides much larger tissue resection that can be used to find the most important biology of a given tissue section rather than being restricted to small tissue samples that might not capture the biology of interest. The pre-embedding of metal-conjugated antibodies, for example, avoids problems inherent in post embedding including the fact that antigens can be destroyed in such processes.

According to the present disclosure, regions of interest may be identified in a tissue, for example, using morphology hallmarks or other approaches. This allows one to look at large fields of view to orient oneself between two imaging modalities, and yet one may zoom in on the same region(s) of interest to capture or image the same region of interest. The regions of interest may be imaged using high resolution electron microscopy to obtain a view of the EM morphology. Markers may then be mapped into context to provide for highly resolved tissue ultrastructure. Thus, morphology information may be combined in terms of shapes and structures with multiplexed molecular identity and chemistry using various markers as described above.

The identification of cell types may be facilitated, for example, not only by shape and morphological hallmarks, but by molecular markers where certain molecules are only present in specific cell types and can serve as molecular markers for such cell types.

In addition, by virtue of multiplexing by way of labeling using metal-conjugated antibodies, stains, and other types of markers, one may identify up to 50 or more different cell types. The molecular markers facilitate correlation cell shape and differentiation. Also, drug targets or proteins of interest may be localized. Further, isotope labeled drugs may be localized within tissues or cells that can be identified by both shape and molecular markers. As such, the present disclosure can have immediate practical application for biomarker research, tissue diagnostics, and pathology.

Beginning with box 273, the method 270 comprises generating a scanning electron microscope image of at least a first portion of an ultramicrotome tissue section of a tissue sample using a scanning electron microscope. Then, in box 276, the method further comprises generating a mass spectrometry image of at least a second portion of the ultramicrotome tissue section using a mass spectrometry imaging platform, where the mass spectrometry image depicts an antibody labeling of at least one element. In box 279, the method comprises registering the scanning electron microscope image with the mass spectrometry image. Thereafter, the method 270 ends as shown.

With reference to FIGS. 1 through 9, in view of the foregoing discussion, below is a description of various features and examples of the present disclosure. It is understood that the below features and examples are not an exhaustive recitation of those possible in the present disclosure.

Clause 1 is a method, comprising generating a scanning electron microscope image of at least a first portion of an ultramicrotome tissue section of a tissue sample using a scanning electron microscope, generating a mass spectrometry image of at least a second portion of the ultramicrotome tissue section using a mass spectrometry imaging platform, where the mass spectrometry image depicts an antibody labeling of at least one element, and registering the scanning electron microscope image with the mass spectrometry image.

Clause 2 comprises a method as set forth in clause 1, further comprising identifying a first region of interest in the ultramicrotome tissue section of the tissue sample, wherein the at least the first portion of the ultramicrotome tissue section comprises the first region of interest.

Clause 3 comprises a method as set forth in clause 2, further comprising identifying a second region of interest in the ultramicrotome tissue section, the second region of interest comprises the at least the second portion of the ultramicrotome tissue section.

Clause 4 comprises a method as set forth in clause 3, wherein the second region of interest overlaps the first region of interest.

Clause 5 comprises a method as set forth in any one of clauses 1 through 4, wherein the registering of the scanning electron microscope image with the mass spectrometry image is conducted using a landmark registration.

Clause 6 comprises a method as set forth in any one of clauses 1 through 4, wherein the registering of the scanning electron microscope image with the mass spectrometry image is conducted using a whole slide registration.

Clause 7 comprises a method as set forth in any one of clauses 1 through 6, wherein the ultramicrotome tissue section of the tissue sample has a cross-sectional area that is greater than 1 square millimeter.

Clause 8 comprises a method as set forth in any one of clauses 1 through 6, wherein the ultramicrotome tissue section of the tissue sample has a cross-sectional area that is greater than 3 square millimeters.

Clause 9 comprises a method as set forth in any one of clauses 1 through 6, further comprising adjusting a resolution of the mass spectrometry image to match a resolution of the scanning electron microscope image.

Clause 10 comprises a method as set forth in any one of clauses 1 through 6, further comprising adjusting a resolution of the scanning electron microscope image to match a resolution of the mass spectrometry image.

Clause 11 comprises a method as set forth in any one of clauses 1 through 10, further comprising soaking the tissue sample in a solution including a chromatin marker before performing an ultramicrotome sectioning of the tissue sample to produce the ultramicrotome tissue section from the tissue sample, where the chromatin marker increases a contrast between a chromatin element in the ultramicrotome tissue section targeted by the chromatin marker and another portion of the ultramicrotome tissue section.

Clause 12 comprises a method as set forth in any one of clauses 1 through 10, further comprising soaking the tissue sample in a solution including a membrane marker before performing an ultramicrotome sectioning of the tissue sample to produce the ultramicrotome tissue section from the tissue sample, where the membrane marker increases a contrast between a membrane in the ultramicrotome tissue section targeted by the membrane marker and another portion of the ultramicrotome tissue section.

Clause 13 comprises a method as set forth in any one of clauses 1 through 12, further comprising soaking a raw tissue sample in a solution having a concentration of at least 60% sucrose, freezing the raw tissue sample for a cryostat sectioning, performing the cryostat sectioning on the raw tissue sample to produce a cryostat tissue section, mounting the cryostat tissue section onto a slide; and covering the cryostat tissue section on the slide with the solution having the concentration of at least 60% sucrose.

Clause 14 comprises a method as set forth in any one of clauses 1 through 13, further comprising performing a pre-embedding of at least one metal-conjugated antibody into the cryostat tissue section.

Clause 15 is a system, comprising a scanning electron microscope image generated using a scanning electron microscope and stored in at least one memory, the scanning electron microscope image depicting at least a first portion of an ultramicrotome tissue section of a tissue sample; a mass spectrometry image generated using a mass spectrometry imaging platform and stored in the at least one memory, the mass spectrometry image depicting at least a second portion of the ultramicrotome tissue section; and at least one processor circuit configured to execute instructions, that cause the at least one processor circuit to register the scanning electron microscope image with the mass spectrometry image.

Clause 16 comprises a system as set forth in clause 15, wherein the registering of the scanning electron microscope image with the mass spectrometry image is conducted using a landmark registration.

Clause 17 comprises a system as set forth in clause 15, wherein the registering of the scanning electron microscope image with the mass spectrometry image is conducted using a whole slide registration.

Clause 18 comprises a system as set forth in any one of clauses 15 through 17, wherein the ultramicrotome tissue section of the tissue sample has a cross section that is greater than 3 square millimeters.

Clause 19 comprises a system as set forth in any one of clauses 15 through 18, wherein the ultramicrotome tissue section is from the tissue sample that is soaked in a solution that includes a marker before performing an ultramicrotome sectioning of the tissue sample to produce the ultramicrotome tissue section, where the marker increases a contrast between a discernible element in the ultramicrotome tissue section targeted by the marker and another portion of the ultramicrotome tissue section.

Clause 20 comprises a non-transitory, computer-readable medium comprising machine-readable instructions that, when executed by a processor of a computing device, cause the computing device to register a scanning electron microscope image with a mass spectrometry image to generate a multilayer image, where the scanning electron microscope image depicts at least a first portion of an ultramicrotome tissue section of a tissue sample using a scanning electron microscope, and the mass spectrometry image depicts at least a second portion of the ultramicrotome tissue section using a mass spectrometry imaging platform, the second portion of the ultramicrotome tissue section at least partially overlapping the first portion of the ultramicrotome tissue section.

Clause 21 comprises a non-transitory, computer-readable medium as set forth in clause 20, wherein the registering of the scanning electron microscope image with the mass spectrometry image is conducted using a landmark registration.

Clause 22 comprises a non-transitory, computer-readable medium as set forth in clause 20, wherein the registering of the scanning electron microscope image with the mass spectrometry image is conducted using a whole slide registration.

Clause 23 comprises a non-transitory, computer-readable medium as set forth in any one of clauses 20 through 22, wherein the ultramicrotome tissue section of the tissue sample has a cross section that is greater than 1 square millimeter.

Clause 24 comprises a non-transitory, computer-readable medium as set forth in any one of clauses 20 through 23, wherein the machine-readable instructions that, when executed by the processor of the computing device, cause the computing device to adjust a first resolution of the mass spectrometry image to match a second resolution associated with the scanning electron microscope image.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that at least one of X, at least one of Y, or at least one of Z to each be present.

It should be emphasized that the above-described features and examples of the present disclosure are merely possible examples of implementations set forth for a clear understanding of the principles of the disclosure. Many variations and modifications can be made to the above-described features or examples without departing substantially from the spirit and principles of the disclosure. All such modifications and variations are intended to be included herein within the scope of this disclosure and protected by the following claims.

Therefore, the following is claimed:

1. A method, comprising:
generating a scanning electron microscope image of at least a first portion of an ultramicrotome tissue section of a tissue sample using a scanning electron microscope;
generating a mass spectrometry image of at least a second portion of the ultramicrotome tissue section using a mass spectrometry imaging platform, where the mass spectrometry image depicts an antibody labeling of at least one element; and
registering the scanning electron microscope image with the mass spectrometry image.

2. The method of claim 1, further comprising identifying a first region of interest in the ultramicrotome tissue section of the tissue sample, wherein the at least the first portion of the ultramicrotome tissue section comprises the first region of interest.

3. The method of claim 2, further comprising identifying a second region of interest in the ultramicrotome tissue section, the second region of interest comprises the at least the second portion of the ultramicrotome tissue section.

4. The method of claim 1, wherein the registering of the scanning electron microscope image with the mass spectrometry image is conducted using a landmark registration or a whole slide registration.

5. The method of claim 1, wherein the ultramicrotome tissue section of the tissue sample has a cross-sectional area that is greater than 1 square millimeter.

6. The method of claim 1, further comprising adjusting a resolution of the mass spectrometry image to match a resolution of the scanning electron microscope image.

7. The method of claim 1, further comprising adjusting a resolution of the scanning electron microscope image to match a resolution of the mass spectrometry image.

8. The method of claim 1, further comprising soaking the tissue sample in a solution including a chromatin marker before performing an ultramicrotome sectioning of the tissue sample to produce the ultramicrotome tissue section from the tissue sample, where the chromatin marker increases a contrast between a chromatin element in the ultramicrotome tissue section targeted by the chromatin marker and another portion of the ultramicrotome tissue section.

9. The method of claim 1, further comprising soaking the tissue sample in a solution including a membrane marker before performing an ultramicrotome sectioning of the tissue sample to produce the ultramicrotome tissue section from the tissue sample, where the membrane marker increases a contrast between a membrane in the ultramicrotome tissue section targeted by the membrane marker and another portion of the ultramicrotome tissue section.

10. The method of claim 9, further comprising:
soaking a raw tissue sample in a solution having a concentration of at least 60% sucrose;
freezing the raw tissue sample for a cryostat sectioning;
performing the cryostat sectioning on the raw tissue sample to produce a cryostat tissue section;
mounting the cryostat tissue section onto a slide; and
covering the cryostat tissue section on the slide with the solution having the concentration of at least 60% sucrose, where the cryostat tissue section comprises the tissue sample.

11. A system, comprising:
a scanning electron microscope image generated using a scanning electron microscope and stored in at least one memory, the scanning electron microscope image depicting at least a first portion of an ultramicrotome tissue section of a tissue sample;
a mass spectrometry image generated using a mass spectrometry imaging platform and stored in the at least one memory, the mass spectrometry image depicting at least a second portion of the ultramicrotome tissue section; and
at least one processor circuit configured to execute instructions, the instructions causing the at least one processor circuit to register the scanning electron microscope image with the mass spectrometry image.

12. The system of claim 11, wherein the registering of the scanning electron microscope image with the mass spectrometry image is conducted using a landmark registration.

13. The system of claim 11, wherein the registering of the scanning electron microscope image with the mass spectrometry image is conducted using a whole slide registration.

14. The system of claim 11, wherein the ultramicrotome tissue section of the tissue sample has a cross section that is greater than 3 square millimeters.

15. The system of claim 11, wherein the ultramicrotome tissue section is from the tissue sample that is soaked in a solution that includes a marker before performing an ultramicrotome sectioning of the tissue sample to produce the ultramicrotome tissue section, where the marker increases a contrast between a discernible element in the ultramicrotome tissue section targeted by the marker and another portion of the ultramicrotome tissue section.

16. A non-transitory, computer-readable medium comprising machine-readable instructions that, when executed by a processor of a computing device, cause the computing device to:
register a scanning electron microscope image with a mass spectrometry image to generate a multilayer image, where the scanning electron microscope image depicts at least a first portion of an ultramicrotome tissue section of a tissue sample using a scanning electron microscope, and the mass spectrometry image depicts at least a second portion of the ultramicrotome tissue section using a mass spectrometry imaging platform, the second portion of the ultramicrotome tissue section at least partially overlapping the first portion of the ultramicrotome tissue section.

17. The non-transitory, computer-readable medium of claim 16, wherein the registering of the scanning electron microscope image with the mass spectrometry image is conducted using a landmark registration.

18. The non-transitory, computer-readable medium of claim 16, wherein the registering of the scanning electron microscope image with the mass spectrometry image is conducted using a whole slide registration.

19. The non-transitory, computer-readable medium of claim 16, wherein the ultramicrotome tissue section of the tissue sample has a cross section that is greater than 1 square millimeter.

20. The non-transitory, computer-readable medium of claim 16, wherein the machine-readable instructions that, when executed by the processor of the computing device, cause the computing device to adjust a first resolution of the mass spectrometry image to match a second resolution associated with the scanning electron microscope image.
